(19) United States
(12) Patent Application Publication
(10) Pub. No.: US 2024/0333003 A1
(43) Pub. Date: Oct. 3, 2024

(54) Portable Modular Charging System

(71) Applicant: Magfast LLC, Cornwall On Hudson, NY (US)

(72) Inventor: Seymour Segnit, Cornwall On Hudson, NY (US)

(21) Appl. No.: 18/616,366

(22) Filed: Mar. 26, 2024

Related U.S. Application Data
(60) Provisional application No. 63/454,995, filed on Mar. 28, 2023.

(51) Int. Cl. H02J 7/00; A45C 3/00; A45C 13/00

(52) U.S. Cl. CPC H02J 7/0045; A45C 3/00; A45C 13/001; A45C 2003/008

(57) ABSTRACT

A portable modular charging system is in a suitcase assembly, including a case having a front face and a cutout within the front face, a housing, having a recess for receiving a battery pack a retention plate; and a movable latch mechanism, retained in the cutout of the front face, the housing having a movable latch and latch release and a battery pack having at least one electrical output for charging an electrical device. The battery pack may be retained within housing and removably retained by the latch and an optional lifter assembly for raising the battery pack from the recess housing when the latch is released may be included. An extensible handle may have parallel rails for the handle such that the housing fits between the rails without interfering with the extension of the handle. One electrical output for charging an electrical device is a wireless charger such as a Qi charger.

This claims the benefit of U.S. Provisional Patent Application Ser. No. 63/454,995 filed Mar. 28, 2023 and hereby incorporated by reference in its entirety.

### TECHNICAL FIELD AND INDUSTRIAL

### Applicability of the Invention

The present invention relates to a portable charger for powering and charging additional accessories for use with electronic components. The portable modular charging system of the present invention is housed within a suitcase or any suitable piece of luggage or surface and typically includes one or more electrical outlets, charge cable connections such as Apple Lightning, USB-C, micro-USB, on the front face of the charger with an adaptor suitable for insertion into a major face of a piece of luggage. Preferably, the adaptor may include a space for storage of an electrical cable for charging storage batteries within the charger. An insert may be permanently mounted to the luggage or surface to temporarily retain the adaptor and charger. The charger of the present invention is suitable for use in any major country and may be adapted to the outlet configuration and voltage of those countries.

### BACKGROUND OF THE INVENTION

Travelers are using charging devices in greater numbers. While some suitcases are available that are housed within suitcases these units are small and do not provide options for multiple devices to be charged nor do they include a variety of inputs and outputs. Typically, the available chargers are located within the case and therefore wireless charging is not possible. Further, typical charging devices must be removed from the case for charging or access to all ports. Generally, the charging devices includes a standardized bus port, such as a Universal Serial Bus Port (USB) or other manufacturer specific port, as both input and output. Travelers have a number of devices, such as mobile phones, e-readers, tablets, notepad computers and other portable electronic devices and there is a need for improved portable charging solutions.

### SUMMARY OF THE INVENTION

The present invention discloses a portable modular charging system in a suitcase assembly, including a case having a front face and a cutout within the front face, a housing, having a recess for receiving a battery pack a retention plate; and a movable latch mechanism, retained in the cutout of the front face, the housing having a movable latch and latch release and a battery pack having at least one electrical output for charging an electrical device. The battery pack may be retained within housing and removably retained by the latch and an optional lifter assembly for raising the battery pack from the recess housing when the latch is released may be included. Preferably, an extensible handle with parallel rails for the handle such that the housing fits between the rails without interfering with the extension of the handle. The preferred electrical output for charging an electrical device is a wireless charger such as a Qi charger.

The device may include other features in the housing such as: a ground fault interrupter, a surge protector a mechanical power interruption switch, a WiFi extender, a thunderbolt connection, a USB connector, a Micro USB connector, an HDMI connector, an Ethernet connector, or any other industry standard connectors, or may include a remote-control unit or an audio connector.

### BRIEF DESCRIPTION OF THE DRAWING

A more complete appreciation of the invention and the many embodiments thereof will be readily obtained as the same becomes better understood by reference to the following detailed description when considered in connection with the accompanying drawings, wherein:

FIG. 1 is a front plan view of a portable modular charging system according to the present invention;

FIG. 2 is an upper perspective view of a in case housing for portable modular charging system and roller case according to the present invention;

FIG. 3 is a perspective view of a release mechanism suitable for use in a portable modular charging system the present invention;

FIG. 4 is a side plan view (partially cut away) of a latch mechanism suitable for use in a portable modular charging system of the present invention.

### DETAILED DESCRIPTION AND PREFERRED

### Embodiments of the Invention

The portable modular charging system for powering and charging additional accessories is shown. The charger of the present invention is typically housed within a suitcase or any suitable piece of luggage, it may also be mounted in any suitable and typically includes one or more electrical outlets, charge cable connections such as Apple Lightning, USB-C, micro-USB, on the front face of the charger with an adaptor suitable for insertion into a major face of a piece of luggage. Preferably, the adaptor may include a space for storage of an electrical cable for charging storage batteries within the charger. The charger of the present invention is suitable for use in any major country and may be adapted to the outlet configuration and voltage of those countries.

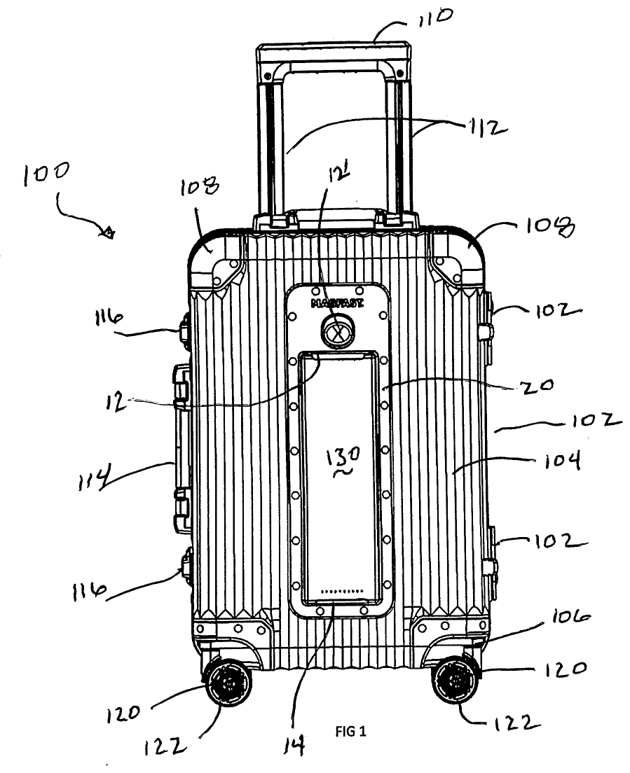

FIG. 1 shows a portable modular charging system in a roller suitcase assembly 100, which includes a case 102 with a front face 104 mounted on hinges 102 and secured with clasps 116. Case 102 may also include an extendable handle 110, rails 112, a carry handle 114, upper corners 108, and lower corners 106. Typically, wheels 122 mounted on axles 120 are included. A housing 20 is placed into a cutout in the front face 104 of case 102. The housing 20 includes a movable latch 12 and latch release 12′, as well as a retention plate 20′. A battery pack 130, which has a number of electrical outputs, typically wireless Qi chargers on the front face, is placed into housing 20 and removably retained by latch 12 and retention plate 20′. The battery pack 130 may be placed in housing 20 to retain it in the case assembly 100 and allow one or more users to charge portable electrical devices while the battery pack 130 remains in case assembly 100. A charge indicator, such as LEDs or LCDs, may be visible on battery pack 130 to indicate that a connection is made with a charging base or the status of the charge in the battery pack 130.

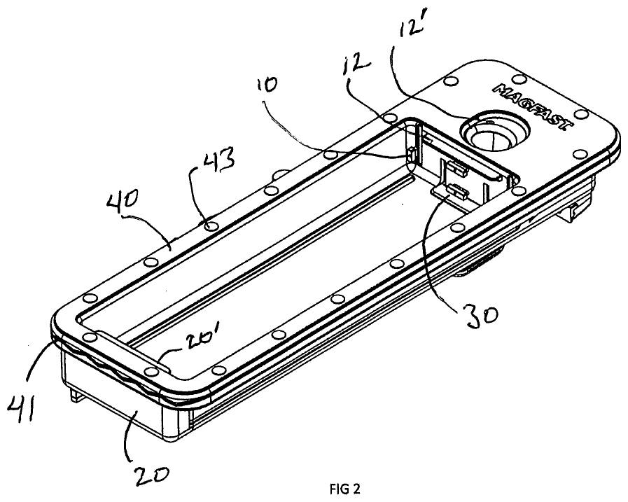

FIG. 2 shows a housing 20 suitable for use with the roller suitcase assembly 100. Housing 20 includes a recess for receiving a battery pack 130. Housing 20 preferably includes a retention plate 20′ and a movable latch mechanism 12, including latch release 12′, for retaining the battery pack 130. Housing 20 may include magnets 10 for aligning the battery pack 130 in the recess and a lifter assembly 30 for raising the battery pack 130 from the recess when the latch release 12′ is moved to release the latch 12. Housing 20 is retained within case assembly 100, and an external plate 40 is attached to the front face 104 with rivets 43, as shown. One or more seals 41 may be included on the exterior or interior of the front face 104.

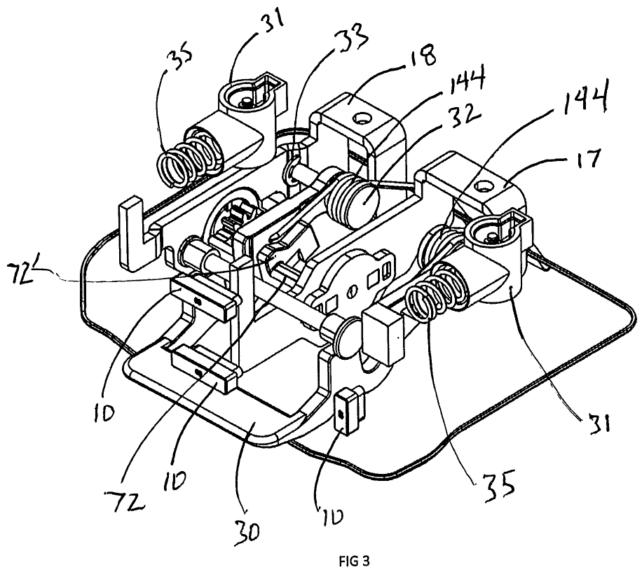

FIG. 3 shows a lifter assembly 30 suitable for use in the roller suitcase assembly 100. The lifter assembly 30 is mounted into a damped torsion spring assembly with at least one damping bracket 17, 18 having a torsion spring 144 mounted to a clevis pin 32 and retaining spring fixture 33. When the latch release 12′ (as shown in FIG. 2) is released, the pawl 72′ releases the internal gear 72 to allow the lifter assembly 30 to rise, lifting the battery pack 130 for easy removal. The latch spring housings 31 and latch springs 35 dampen the lifting speed of the lifter assembly 30. Magnets 9 may be included to align and retain battery pack 130 withing housing 20.

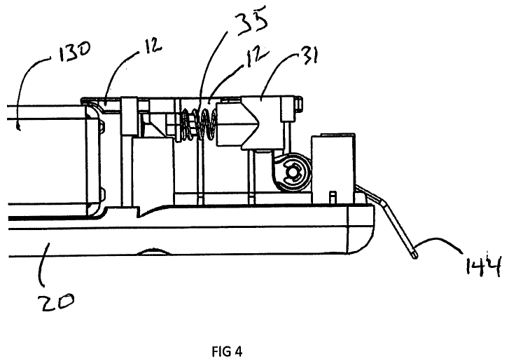

FIG. 4 shows a retention system for battery pack 130 within housing 20, including latch 12, latch compression springs 35 mounted on a latch housing 12B when the latch 12 is moved rearward, battery pack 130 is free to be lifted by the lifter assembly 30 as discussed above.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

I claim:

1. A portable modular charging system in a suitcase assembly, comprising:
a case having a front face and a cutout within the front face;
a housing retained in the cutout of the front face, the housing having a movable latch and latch release; and
a battery pack retained within housing and removably retained by the latch.

2. The portable modular charging system in a suitcase assembly of claim 1, wherein the battery pack includes at least one electrical output for charging an electrical device.

3. The portable modular charging system in a suitcase assembly of claim 2, wherein the electrical outputs for charging an electrical device are wireless Qi chargers

4. The portable modular charging system in a suitcase assembly of claim 1, wherein the housing further comprises:
a recess for receiving;
a battery pack a retention plate; and
a movable latch mechanism.

5. The portable modular charging system in a suitcase assembly of claim 4, wherein the housing further comprises:
a lifter assembly for raising the battery pack from the recess housing when the latch is released.

6. The portable modular charging system in a suitcase assembly of claim 1, wherein the housing is retained within the case, and an external plate is attached to the case to secure the housing to the case.

7. The portable modular charging system in a suitcase assembly of claim 6, further comprising:
at least one seal between the external plate, the case and the housing.

8. The portable modular charging system in a suitcase assembly of claim 1, further comprising:
an extensible handle with parallel rails for the handle and the housing is configured to fit between the rails without interfering with the extensibility thereof.

9. A portable modular charging system in a suitcase assembly, comprising:
a case having a front face and a cutout within the front face;
a housing, having a recess for receiving a battery pack a retention plate; and
a movable latch mechanism, retained in the cutout of the front face, the housing having a movable latch and latch release;
a battery pack having at least one electrical output for charging an electrical device retained within housing and removably retained by the latch.

10. The portable modular charging system in a suitcase assembly of claim 9, wherein the electrical outputs for charging an electrical device are wireless Qi chargers

11. The portable modular charging system in a suitcase assembly of claim 9, wherein the housing further comprises:
a lifter assembly for raising the battery pack from the recess housing when the latch is released.

12. The portable modular charging system in a suitcase assembly of claim 9, wherein the housing is retained within the case, and an external plate is attached to the case to secure the housing to the case.

13. The portable modular charging system in a suitcase assembly of claim 1, further comprising:
an extensible handle with parallel rails for the handle and the housing is configured to fit between the rails without interfering with the extensibility thereof.

14. A portable modular charging system in a suitcase assembly, comprising:
a case having a front face and a cutout within the front face;
a housing, having a recess for receiving a battery pack a retention plate; and a movable latch mechanism, retained in the cutout of the front face, the housing having a movable latch and latch release;
a battery pack having at least one electrical output for charging an electrical device retained within housing and removably retained by the latch;
a lifter assembly for raising the battery pack from the recess housing when the latch is released; and
an extensible handle with parallel rails for the handle and the housing is configured to fit between the rails without interfering with the extensibility thereof.

15. The portable modular charging system in a suitcase assembly of claim 9, wherein the electrical outputs for charging an electrical device are wireless Qi chargers

16. The portable modular charging system in a suitcase assembly of claim 9, wherein the housing is retained within the case, and an external plate is attached to the case to secure the housing to the case.
